(19) United States
(12) Patent Application Publication
(10) Pub. No.: US 2026/0030560 A1
(43) Pub. Date: Jan. 29, 2026

(54) ARTIFICIAL INTELLIGENCE AGGREGATION

(71) Applicant: KONINKLIJKE PHILIPS N.V., EINDHOVEN (NL)

(72) Inventors: SHIVA MOORTHY POOKALA VITTAL, BANGALORE (IN); RICHARD VDOVJAK, WAALRE (NL); ALEKSANDR BUKHAREV, EINDHOVEN (NL); ANSHUL JAIN, BANGALORE (IN); SHREYA ANAND, BANGALORE (IN); NIKOLAY PROKOPTSEV, MOSCOW (RU); RACHAKONDA SIDDARTHA, BANGALORE (IN)

(21) Appl. No.: 18/998,534

(22) PCT Filed: Jul. 21, 2023
(86) PCT No.: PCT/EP2023/070307

§ 371 Date: Jan. 27, 2025

(30) Foreign Application Priority Data
Jul. 27, 2022 (RU) 2022120508

(51) Int. Cl. G06N 20/20

(52) U.S. Cl. CPC G06N 20/20

(57) ABSTRACT

An artificial intelligence aggregation system (110) includes a computer (500) and a memory system. The computer (500) includes a memory (520) that stores instructions and a processor (510) that executes the instructions. The memory system aggregates (S326) a first set of updates to an initial model in a federated learning process. The computer (500) executes the instructions to: distribute (FIG. 3B), to sources of the first set of updates in a federation, a first aggregated updated model that aggregates updates to the initial model; and distribute (FIG. 3B), to a first new source, either the initial model or the first aggregated updated model.

### BACKGROUND

Federated learning is a machine learning technique for training a machine learning model across multiple decentralized devices. In federated learning, each machine trains on local data without explicitly sharing the local data with the other machines. The major advantage of federated learning is access to large amounts of data, which is typically unavailable due to privacy concerns. During federated learning, some devices in a federation may be unavailable and may only be able to join after the machine learning model (e.g., a neural network model) has been successfully trained. This poses a challenge of integrating new knowledge into the federation.

Incremental learning is a machine learning paradigm in which a machine learning model is not retrained from scratch, and instead the machine learning model is continually trained, raising the possibility of “catastrophic forgetting”. In other words, the machine learning model may forget some previous train samples, and this phenomenon is known as “catastrophic forgetting”. Catastrophic interference, also known as catastrophic forgetting, is the tendency of an artificial neural network to completely and abruptly forget previously learned information upon learning new information. The problem is that when a neural network is used to train a machine learning model, the learning of the historical machine learning model may be overridden with the current machine learning model.

Incremental learning methods can be coarsely divided into three groups: regularization-based methods, parameter isolation methods, and replay methods. Regularization-based methods introduce an extra term to loss function aimed at preventing catastrophic forgetting when learning on new data. Most of these methods estimate regularization parameters from training data, making regularization-based methods unsuitable for a federated learning setup. Parameter isolation methods work by assigning different model parameters for each task. These methods show the best performance of the three, but require some network modification such as compression or masking. Replay methods use additional memory to store training samples or make use of generative models.

Federated learning and incremental learning may be mixed, such as when previous data-samples are not available for a next round of training and the machine learning model is trained on a new dataset. In general, such a solution is applicable in particular cases when it is hard or even impossible to design and train a generalizable deep neural network model once and the deep neural network model must be continually improved. The deep neural network model may be retrained on unseen samples to improve robustness. Unfortunately, the actual accuracy of the machine learning model may deteriorate after the re-training.

Machine learning models developed to address catastrophic forgetting are limited in that the machine learning models can only learn from their own direct experience, i.e., can only learn from the sequence of the tasks it has trained on.

### SUMMARY

According to an aspect of the present disclosure, an artificial intelligence aggregation system includes a computer and a memory system. The computer includes a memory that stores instructions and a processor that executes the instructions. The memory system aggregates a first set of updates to an initial model in a federated learning process. The computer executes the instructions to: distribute, to sources of the first set of updates in a federation, a first aggregated updated model that aggregates updates to the initial model; and distribute, to a first new source, either the initial model or the first aggregated updated model.

According to another aspect of the present disclosure, a computer-implemented method for federated learning includes aggregating, in a memory system, a first set of updates to an initial model in a federated learning process; distributing, to sources of the first set of updates in a federation, a first aggregated updated model that aggregates updates to the initial model; and distributing, to a first new source, either the initial model or the first aggregated updated model.

According to another aspect of the present disclosure, a tangible non-transitory computer readable medium stores a computer program. The computer program, when executed by a processor, causes a computer apparatus to: distribute, to sources of a first set of updates to an initial model in a federated learning process in a federation, a first aggregated updated model that aggregates the first set of updates to the initial model in the federated learning process; and distribute, to a first new source, either the initial model or the first aggregated updated model.

According to another aspect of the present disclosure, an artificial intelligence aggregation system includes sources and a computer. The sources each include a computer with a memory that stores instructions and a processor that executes the instructions. The computer includes a memory, a processor and a computer system. The memory stores instructions. The processor executes the instructions. The memory system aggregates a first set of updates to an initial model in a federated learning process. The computer executes the instructions to: distribute, to the sources of the first set of updates in a federation, a first aggregated updated model that aggregates updates to the initial model; and distribute, to a first new source, either the initial model or the first aggregated updated model.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 illustrates a network for artificial intelligence aggregation, in accordance with a representative embodiment.

FIG. 2 illustrates a hybrid network and data flow for artificial intelligence aggregation, in accordance with a representative embodiment.

FIG. 3A illustrates a method for artificial intelligence aggregation, in accordance with a representative embodiment.

FIG. 3B illustrates a method for artificial intelligence aggregation, in accordance with a representative embodiment.

FIG. 3C illustrates a method for artificial intelligence aggregation, in accordance with a representative embodiment.

FIG. 3D illustrates a method for artificial intelligence aggregation, in accordance with a representative embodiment.

FIG. 4 illustrates convergence to an objective in a federated training procedure for artificial intelligence aggregation, in accordance with a representative embodiment.

FIG. 5 illustrates a computer system, on which a method for artificial intelligence aggregation is implemented, in accordance with another representative embodiment.

### DETAILED DESCRIPTION

In the following detailed description, for the purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

The terminology used herein is for purposes of describing particular embodiments only and is not intended to be limiting. As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, “coupled to”, or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

As described herein, artificial intelligence aggregation is developed as a private version of replay methods. A coordinator or aggregator is provided access to aggregated gradients. Individual updates from federated learning sources may be provided to the coordinator or aggregator, and reused further when future leaning happens. An aggregated machine learning model may be used to apply existing learned structures to the current machine learning model.

Notably, certain details of federated learning may be found in commonly owned U.S. Provisional Application No. 63/089,159, entitled “Decentralized training method suitable for disparate training sets” filed on Oct. 8, 2020; and in commonly owned U.S. Provisional Application No. 63/094,561, entitled “Federated Learning” filed on Oct. 21, 2020. The entire disclosures of U.S. Provisional Application Nos. 63/089,159 and 63/094,561 are specifically incorporated herein by reference (copies of these applications are attached to this filing).

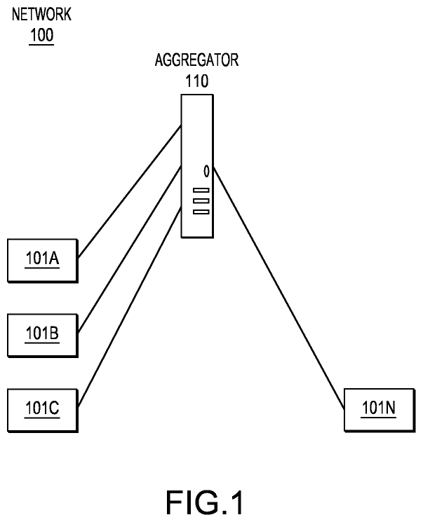

FIG. 1 illustrates a network for artificial intelligence aggregation, in accordance with a representative embodiment.

The network 100 in FIG. 1 includes an aggregator 110, a first source 101A, a second source 101B, a third source 101C, and an nth source 101N. Initially, the first source 101A, the second source 101B and the third source 101C are elements of a federation for federated learning. The nth source 101N is a first new source that is added to the federation, though there is no particular limit to the number of sources that can be added to the federation. For example, a second new source and a third new source (not shown) may be added to the federation. The federation is configured to perform federated learning to develop machine learning models.

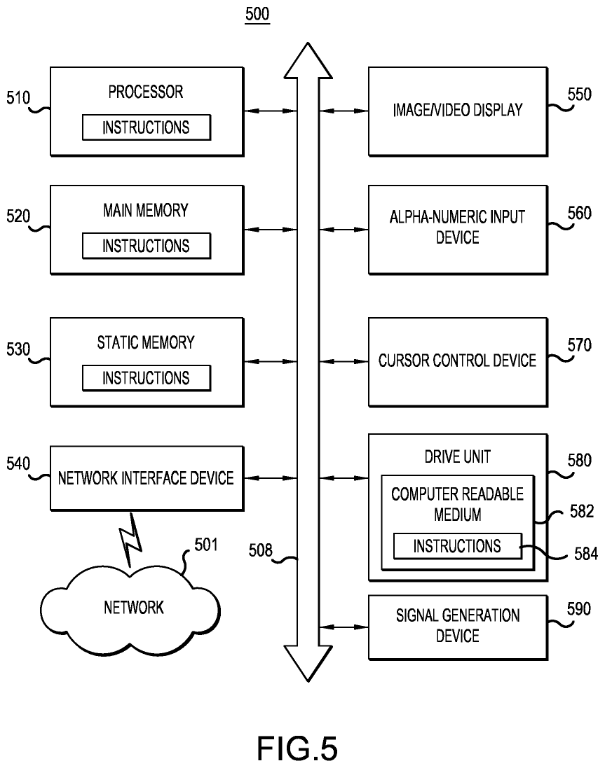

Each of the aggregator 110, the first source 101A, the second source 101B, the third source 101C, and the nth source 101N, as well as any other source described herein, comprises an electronic communication device. An electronic communication device includes at least a memory that stores instructions, a processor that executes the instructions, and circuits such as interfaces configured to communicate over electronic communication networks. An example of a computer system on which the aggregator 110, the first source 101A, the second source 101B, the third source 101C and the nth source 101N can be based is shown in and described with respect to FIG. 5.

That is, the aggregator 110 includes a computer with a memory that stores instructions and a processor that executes the instructions. The aggregator 110 also includes a memory system that aggregates updates such as a first set of updates to an initial model in a federated learning process, a second set of updates to an initial model in a federated learning process, and so on.

In some embodiments, the aggregator 110 is an artificial intelligence aggregation system independent of the first source 101A, the second source 101B, the third source 101C and the nth source 101N, such as when the aggregator 110 is provided as a third-party service. In other embodiments, an artificial intelligence aggregation system includes the aggregator 110, the first source 101A, the second source 101B, the third source 101C and the nth source 101N, such as when all of the elements in FIG. 1 are provided by the same entity such as a hospital system.

The aggregator 110 is therefore a computer with a memory that stores instructions and a processor that executes the instructions, along with a memory system that aggregates a first set of updates to an initial model in a federated learning process. The aggregator 110 may also be provided as a distributed system, for example via a cloud, at one or more data centers. For example, multiple servers may provide services attributed to the aggregator 110 herein for multiple different customers, and each customer may include its own set of sources corresponding to the first source 101A, the second source 101B and the third source 101C. In a distributed system, a first server in a data center in the cloud may serve as an aggregator 110 at one time, and another server in the same or a different data center in the cloud may serve as the aggregator 110 for the same customer at a different time.

As sources in a federation, the first source 101A, the second source 10B and the third source 101C contribute a first set of updates to an initial machine learning model. As an artificial intelligence aggregation system, the aggregator 110 is configured to distribute, to the sources (i.e., the first source 101A, the second source 101B and the third source 101C) of the first set of updates in the federation, a first aggregated updated model that aggregates updates to the initial model, and distribute, to a first new source (i.e., the nth source 101N), either the initial model or the first aggregated updated model.

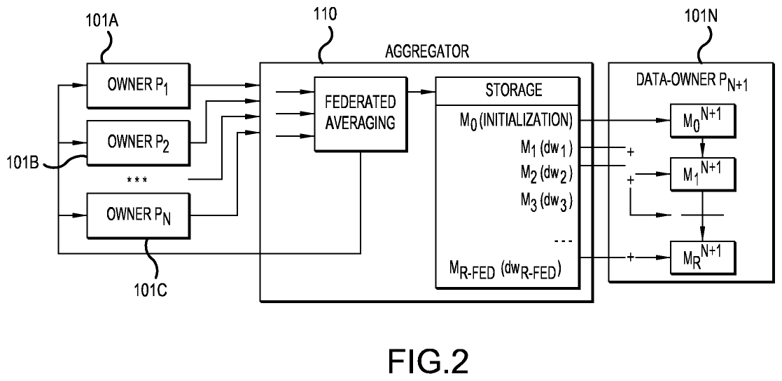

FIG. 2 illustrates a hybrid network and data flow for artificial intelligence aggregation, in accordance with a representative embodiment.

In FIG. 2, the hybrid network includes the aggregator 110, the first source 101A, the second source 101B, the third source 101C and the nth source 101N. The first source 101A is labelled as owner P1, the second source 101B is labelled as owner P2, the third source 101C is labelled as owner PN, and the nth source 101N is labelled as owner PN+1. The aggregator 110 aggregates a first set of updates to an initial model in a federated learning process, and then distributes to the sources of the first set of updates a first aggregated updated model that aggregates the updates to the initial model. The aggregator 110 may aggregate the first set of updates to the initial model by averaging (e.g., weighted averaging) the first set of updates to the initial model. The aggregator 110 also distributes, to the nth source 101N as a first new source, either the initial model or the first aggregated updated model.

The hybrid network in FIG. 2 addresses the “catastrophic forgetting” problem in a scenario of federated learning. In more detail, the hybrid network in FIG. 2 is a federated learning system. The aggregator 110 is a coordinator that stores individual updates from federated learning workers. When future learning happens, the individual updates from federated learning workers are re-used. The aggregated model is configured to apply existing learned structures to a model trained on a new dataset, such as at the nth source 101N as a first new source. A final aggregated model may consider the structures from all of the workers in the hybrid network in FIG. 2.

In some embodiments based on the hybrid network in FIG. 2, segmentation of multiple sclerosis lesions may serve as a demonstrative example. The task for the segmentation involves detecting and segmenting the white matter lesions associated with multiple sclerosis (MS) on magnetic resonance imaging (MRI) images of a brain. A mask is a binary image consisting of zero, referring to unaffected regions of a brain, and non-zero values, marking white matter MS lesions. A segmentation algorithm forms masks based on MRI images. Then, the characteristic(s) derived from the lesion masks (such as size and location of lesions) may be used for MS treatment to improve MS therapy. Multiple MS open datasets and evaluation platforms have been created to encourage research work on this problem. According to recent published evaluation results the approaches based on deep learning are the most promising options. According to the teachings herein, a fully convolution neural network (CNN) may be used as a core model, though other deep learning models may be used. The model utilizes MRI images of a brain in the T2 modality and the FLAIR modality as an input to delineate the edges of MS lesions. Table 1 below shows four independent parts of a demonstrative dataset.

TABLE 1

| Participants | P₁ | P₂ | P₃ | P₄ |
|---|---|---|---|---|
| Number of samples | 21 * | 30 | 15 | 15 |
| Ratio of the classes | 0.5 * 10⁻² | 1.1 * 10⁻² | 0.35 * 10⁻² | 0.85 * 10⁻² |
| Total lesion volume | 23% | 46% | 7% | 24% |

Each of the independent parts of the dataset shown in Table 1 is collected from different sites. The first three parts consist of a federated trainset used during the initial training. The last one is a dataset which simulates the source of unseen “hard” samples. The datasets are collected from different hospitals and vary in terms of data acquisition process, patients age, stage of the disease, available MRI modalities, etc. These settings are consistent with the necessity for continuous improvement of the considered deep neural network model. The dataset in Table 1 is processed in three stages including federated training, a visualization of the “forgetting” issue, and training on data from a new source.

For federated training, the first three participants (P1, P2, P3) are united to train a federated model M (D) jointly according to the hybrid network shown in FIG. 2. The aggregator 110 serves as a coordinator and averages the updates δwᵢₖ from each of the initial sources (P1). When the last update is received from the initial sources (P₁), the aggregator 110 sends an averaged update δWₖ=N⁻¹sum(δwᵢₖ) back and the training round is repeated. Each of the initial sources (P₁) participates in all the rounds executing n=100 local optimization steps. The loss is calculated for small two-dimensional patches merged into batches with size b=100. These hyperparameters and an aggregation schema enable reproducibility of the experiments but may be considered arbitrary. Also, the participants may modify the updates δwᵢₖ=T (δwᵢₖ) before sending the updates to the aggregator 110, in order to reduce size of the update and to satisfy privacy and security requirements and so on.

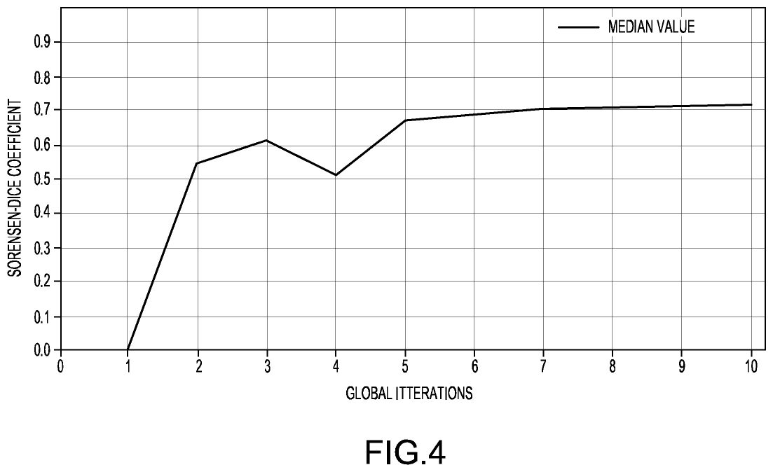

The federated training procedure executes until the convergence of the objective. Convergence of the objective is shown in and described with respect to FIG. 4. The total number of iterations R_{fed} is 10 in the convergence illustrated in FIG. 4. The aggregator 110 obtains the model Mₖ(D) and all the intermediate global updates δwₖ after the training and aggregates the model and all the intermediate global updates to the initial model for further usage.

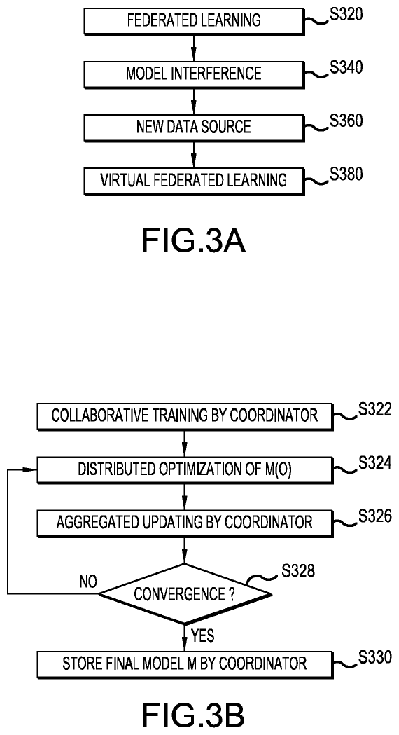

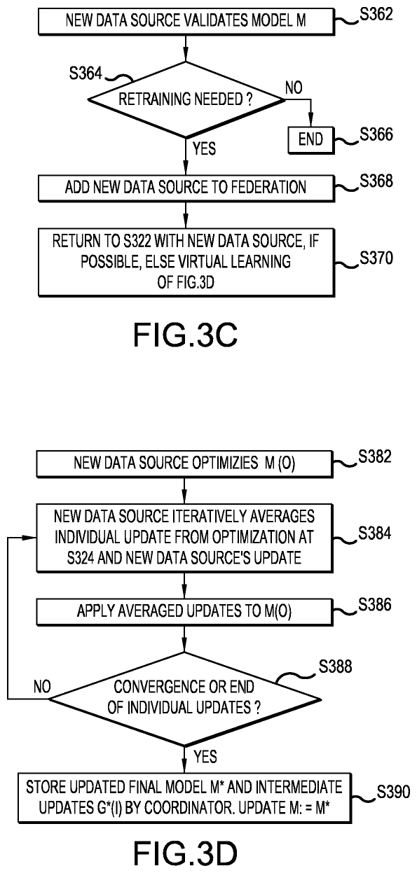

FIG. 3A illustrates a method for artificial intelligence aggregation, in accordance with a representative embodiment.

The method of FIG. 3A starts at S320 with federated learning. The federated learning at S320 may include aggregating a first set of updates to an initial model in a federated learning process, after which the aggregator 110 may distribute to the sources of the first set of updates a first aggregated updated model that aggregates updates to the initial model. Federated learning is described more with respect to FIG. 3B.

At S340, the method of FIG. 3A includes model inference. That is, each of the sources in the federation may apply the first aggregated updated model to new datasets. S340 is consistent with applications of artificial intelligence models such as neural network models, wherein the artificial intelligence models make inferences about new data in new datasets based on the training of the artificial intelligence models.

At S360, the aggregator 110 may initiate adding a new data source to the federation. S360 may be performed repeatedly, such that the aggregator 110 may initiate adding a first new data source to the federation, adding a second new data source to the federation, and so on. Either the initial model or the first aggregated updated model may be distributed to the first new data source, to the second new data source, and so on. Operations relating the new data source are explained more with respect to FIG. 3C.

At S380, the method of FIG. 3A includes virtual federated learning. Virtual federated learning is not particularly required for some embodiments of the artificial intelligence aggregation, but is available as an option in appropriate circumstances. Virtual federated learning is described with respect to FIG. 3D below.

FIG. 3B illustrates a method for artificial intelligence aggregation, in accordance with a representative embodiment.

The method of FIG. 3B starts with collaborative training by a coordinator at S322. The coordinator may be the aggregator 110 in FIG. 1, and the training may be the generation of the initial model M (O).

At S324, the method of FIG. 3B includes distributed optimization of the initial model M (O). As an example, the aggregator 110 may distribute the initial model M (O) to the initial sources, and the initial sources may each optimize the initial model M (O) and create an update among a first set of updates. The first set of updates may then be returned to the aggregator 110.

At S326, the method of FIG. 3B includes aggregated updating by the coordinator. The aggregated updating may involve averaging the initial set of updates, such as by using the same weight or predetermined weights that vary.

At S328, the aggregator 110 determines whether convergence has occurred, such as by determining whether averaged values have converged towards a common value. Convergence may be determined mathematically, such as with reference to one or more ranges of values of the initial set of updates.

If convergence has not occurred (S328=No), the method of FIG. 3B returns to S324. If convergence has occurred (S328=Yes), the aggregator 110 stores the final model M.

FIG. 3C illustrates a method for artificial intelligence aggregation, in accordance with a representative embodiment.

The method of FIG. 3C starts at S362 with a new source validating the final model M. The new source may validate the final model M by applying the final model M to a test dataset and determining whether the result satisfies the metric used to determine convergence at S328. If retraining is not needed (S364=No), the method of FIG. 3C ends as the new source can use the final model M.

If retraining is needed (S364=Yes), at S368 the aggregator adds the new source to the federation.

At S370, the method of FIG. 3C returns to S322 in FIG. 3B, and collaborative training is again performed, now with the new source as part of the federation.

The addition of new sources in FIG. 3C may be performed each time a new source is to be added to the federation.

FIG. 3D illustrates a method for artificial intelligence aggregation, in accordance with a representative embodiment.

At S382, a new data source optimizes the initial model M (O). The new data source may obtain from the aggregator 110 the initial model M (O) and each individual update of the aggregated updates to the initial model M (O) from the distributed optimization at S324 in FIG. 3B. Each new data source that is not enabled to re-start the collaborative training by the coordinator at S322 is instead enabled to perform virtual federated learning remotely, starting with performing the optimizing of the initial model M (O) at S382.

At S384, the new data source iteratively averages individual updates from the optimization at S382 and the new data source's update. Each iteration of S384 involves adding one new weighted individual update to the existing (previous) average. The weights may be computed in accordance with the size of the dataset. For example, a weight may be set as the number of new samples divided by the combination of the number of previous samples and the number of new samples. Each new data source is enabled to apply the initial model M (O) to local data of the new source, and average the aggregated updates to the initial model M (O) and a new update to the initial model based on the new source applying the initial model M (O) to the local data to obtain a new aggregated updated model. For example, a first new data source may obtain a first new aggregated updated model based on applying the initial model M (O) to first local data of the first new source, and a second new data source may obtain a second new aggregated updated model based on applying the initial model M (O) to second local data of the second new source. In this manner, each new source may obtain its own new aggregated updated model by iteratively averaging the aggregated updates to the initial model M (O) and the new data source's update. Each new data source may obtain the initial model M (O) and the aggregated updates to the initial model M (O) from the aggregator 110, and perform these operations as virtual federated learning such as when a new source cannot be added to the federation but the new source is allowed to remotely and virtually contribute to the federated learning in lieu of the aggregator 110.

To more clearly delineate between models updates by the aggregator 110 and models updated by a source, models updated by the aggregator 110 may be referred to herein as an aggregated updated model, and models updates by a source may be referred to herein as a new aggregated updated model.

At S386, the method of FIG. 3D includes applying averaged updates to the initial model M (O). At S388, the method of FIG. 3D includes determining whether convergence has occurred or the last of the individual updates have been averaged. If there is no convergence and one or more individual update remains to be averaged (S388=No), the method of FIG. 3D returns to S384.

If either convergence is reached or no more individual updates remain to be averaged (S388=Yes for either or both criteria), at S390 the updated final model M* is stored along with intermediate updates G* (i) by the coordinator. The final model M is also updated to the updated final model M*. The final model M* is a new aggregated updated model, and is obtained by each new source (i.e., the first new source, the second new source) respectively applying the initial model to local data of the new source, and averaging the aggregated updates to the initial model and a new update to the initial model generated by the new source. The selective generation of a new aggregated updated model remotely at/by each new source when called for is considered a form of virtual federated learning.

The method of FIG. 3A from S320 to S360 may be performed by the aggregator 110 performing aggregated updating and the sources performing distributed optimization. However, the method of FIG. 3D is generally performed by the sources since the optimizing and the virtual federated aggregating is performed by each new source when the method of FIG. 3C at S370 does not return to S322 in FIG. 3B. In the methods of FIG. 3A, FIG. 3B, FIG. 3C and FIG. 3D, catastrophic forgetting is avoided by fine tuning the model. The catastrophic forgetting is avoided by distributing either the initial model or the first aggregated updated model to new sources. Virtual federated learning may be performed remotely using the same pipeline, the loss function and set of the hyperparameters to train the model at each new source as for the initial sources. The model from the new source is not sent to the aggregator 110 after each global round. Instead, the previous updates δwₖ are used to recalculate parameters of the model M⁴. More precisely, after each global round k the model Mₖ⁴ is updated as follows: Mₖ⁴=α(k) Mₖ⁴+β(k) Mₖ, α(k)+β(k)=1. The second term is an intermediate update saved during federated learning training. In general, parameters α(k) and β(k) may be arbitrary depending on the task, number of new train samples, quality of the annotations, etc. Also, if it is necessary, the training may be configured with a smaller number of the updates R≤R_{fed}. In such a case the model is initialized from the predefined state M (R_{fed}-R).

The number of sources participating in a federation may be tracked in a database and used to derive α(k) and β(k) for the “virtual” federated learning round. For four sources including the first new source, equal weights of 0.25 may be used, such that α(k)=0.25, β(k)=0.75.

FIG. 4 illustrates convergence to an objective in a federated training procedure for artificial intelligence aggregation, in accordance with a representative embodiment.

In FIG. 4, convergence occurs around .7 after 5 iterations out of 10 iterations that are performed. The convergence is determined with reference to a median value. That is, a federated training procedure is executed until the convergence of the objective. The aggregator 110 obtains the model Mₖ(D) and all the intermediate global updates δwₖ after the training and saves the model Mₖ(D) and all the intermediate global updates δwₖ into the memory system of the aggregator. The aggregator 110 may also store, without restriction, explainable modules, algorithms to calculate feature importance, and other useful tools that may be useful for new sources, for example. Both the aggregator 110 and any source described herein may aggregate updates to models until convergence is achieved. Sources performing virtual federated learning remotely may stop before convergence is achieved, however, if the end of individual updates is reached at S388 in the iterative process of FIG. 3D.

FIG. 5 illustrates a computer system, on which a method for artificial intelligence aggregation is implemented, in accordance with another representative embodiment.

Referring to FIG. 5, the computer system 500 includes a set of software instructions that can be executed to cause the computer system 500 to perform any of the methods or computer-based functions disclosed herein. The computer system 500 may operate as a standalone device or may be connected, for example, using a network 501, to other computer systems or peripheral devices. In embodiments, a computer system 500 performs logical processing based on digital signals received via an analog-to-digital converter.

In a networked deployment, the computer system 500 operates in the capacity of a server or as a client user computer in a server-client user network environment, or as a peer computer system in a peer-to-peer (or distributed) network environment. The computer system 500 can also be implemented as or incorporated into various devices, such as a computer that serves as an aggregator or source described herein, including a workstation that includes a controller, a stationary computer, a mobile computer, a personal computer (PC), a laptop computer, a tablet computer, or any other machine capable of executing a set of software instructions (sequential or otherwise) that specify actions to be taken by that machine. The computer system 500 can be incorporated as or in a device that in turn is in an integrated system that includes additional devices. In an embodiment, the computer system 500 can be implemented using electronic devices that provide voice, video or data communication. Further, while the computer system 500 is illustrated in the singular, the term “system” shall also be taken to include any collection of systems or sub-systems that individually or jointly execute a set, or multiple sets, of software instructions to perform one or more computer functions.

As illustrated in FIG. 5, the computer system 500 includes a processor 510. The processor 510 may be considered a representative example of a processor of a controller and executes instructions to implement some or all aspects of methods and processes described herein. The processor 510 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 510 is an article of manufacture and/or a machine component. The processor 510 is configured to execute software instructions to perform functions as described in the various embodiments herein. The processor 510 may be a general-purpose processor or may be part of an application specific integrated circuit (ASIC). The processor 510 may also be a microprocessor, a microcomputer, a processor chip, a controller, a microcontroller, a digital signal processor (DSP), a state machine, or a programmable logic device. The processor 510 may also be a logical circuit, including a programmable gate array (PGA), such as a field programmable gate array (FPGA), or another type of circuit that includes discrete gate and/or transistor logic. The processor 510 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 500 further includes a main memory 520 and a static memory 530, where memories in the computer system 500 communicate with each other and the processor 510 via a bus 508. Either or both of the main memory 520 and the static memory 530 may be considered representative examples of a memory of a controller, and store instructions used to implement some or all aspects of methods and processes described herein. Memories described herein are tangible storage mediums for storing data and executable software instructions and are non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 520 and the static memory 530 are articles of manufacture and/or machine components. The main memory 520 and the static memory 530 are computer-readable mediums from which data and executable software instructions can be read by a computer (e.g., the processor 510). Each of the main memory 520 and the static memory 530 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

The inventive concepts described herein encompass a tangible, non-transitory computer readable medium that stores instructions that cause a processor to execute the methods described herein. A computer readable medium is defined to be any medium that constitutes patentable subject matter under 35 U.S.C. § 101 and excludes any medium that does not constitute patentable subject matter under 35 U.S.C. § 101. Examples of such media include non-transitory media such as computer memory devices that store information in a format that is readable by a computer or data processing system.

As shown, the computer system 500 further includes a video display unit 550, such as a liquid crystal display (LCD), an organic light emitting diode (OLED), a flat panel display, a solid-state display, or a cathode ray tube (CRT), for example. Additionally, the computer system 500 includes an input device 560, such as a keyboard/virtual keyboard or touch-sensitive input screen or speech input with speech recognition, and a cursor control device 570, such as a mouse or touch-sensitive input screen or pad. The computer system 500 also optionally includes a disk drive unit 580, a signal generation device 590, such as a speaker or remote control, and/or a network interface device 540.

In an embodiment, as depicted in FIG. 5, the disk drive unit 580 includes a computer-readable medium 582 in which one or more sets of software instructions 584 (software) are embedded. The sets of software instructions 584 are read from the computer-readable medium 582 to be executed by the processor 510. Further, the software instructions 584, when executed by the processor 510, perform one or more steps of the methods and processes as described herein. In an embodiment, the software instructions 584 reside all or in part within the main memory 520, the static memory 530 and/or the processor 510 during execution by the computer system 500. Further, the computer-readable medium 582 may include software instructions 584 or receive and execute software instructions 584 responsive to a propagated signal, so that a device connected to a network 501 communicates voice, video or data over the network 501. The software instructions 584 may be transmitted or received over the network 501 via the network interface device 540.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

Accordingly, artificial intelligence aggregation provides a private version of replay methods. The coordinator or aggregator described herein is provided access to aggregated gradients. Individual updates from federated learning sources may be provided to the coordinator or aggregator, and reused further when future leaning happens. An aggregated machine learning model may be used to apply existing learned structures to the current machine learning model.

The enhanced federated learning framework described herein may be implemented in a service platform for health and wellness solutions, and helps address catastrophic forgetting scenarios. An example implementation for the enhanced federated learning framework is for machine learning models that cannot be retrained after a set point in time, such as after a contract expires.

Although artificial intelligence aggregation has been described with reference to several exemplary embodiments, it is understood that the words that have been used are words of description and illustration, rather than words of limitation. Changes may be made within the purview of the appended claims, as presently stated and as amended, without departing from the scope and spirit of artificial intelligence aggregation in its aspects. Although artificial intelligence aggregation has been described with reference to particular means, materials and embodiments, artificial intelligence aggregation is not intended to be limited to the particulars disclosed; rather artificial intelligence aggregation extends to all functionally equivalent structures, methods, and uses such as are within the scope of the appended claims.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. An artificial intelligence aggregation system, comprising:
a computer with a memory that stores instructions and a processor that executes the instructions; and
a memory system that aggregates a first set of updates to an initial model in a federated learning process, wherein the computer executes the instructions to:
distribute, to sources of the first set of updates in a federation, a first aggregated updated model that aggregates updates to the initial model; and
distribute, to a first new source, either the initial model or the first aggregated updated model.

2. The artificial intelligence aggregation system of claim 1, wherein the computer executes the instructions further to:
initiate adding the first new source to the federation;
aggregate a second set of updates to the first aggregated updated model from the federation including the first new source;
distribute, to sources of the second set of updates in the federation, a second aggregated updated model that aggregates updates to the first aggregated updated model; and
distribute, to a second new source, the second aggregated updated model.

3. The artificial intelligence aggregation system of claim 2, wherein the computer executes the instructions further to:
initiate adding the second new source to the federation;
aggregate a third set of updates to the second aggregated updated model from the federation including the second new source;
distribute, to sources of the third set of updates in the federation, a third aggregated updated model that aggregates updates to the second aggregated updated model; and
distribute, to a third new source, the third aggregated updated model.

4. The artificial intelligence aggregation system of claim 1, wherein the computer executes the instructions further to:
initiate adding the first new source to the federation, wherein the first new source is enabled to apply the initial model to first local data of the first new source, and average the aggregated updates to the initial model and a first new update to the initial model based on the first new source applying the initial model to the first local data to obtain a first new aggregated updated model;
receive the first new update to the initial model from the first new source; and
distribute, to a second new source, either the initial model or the first aggregated updated model.

5. The artificial intelligence aggregation system of claim 4, wherein the computer executes the instructions further to:
initiate adding the second new source to the federation, wherein the second new source is enabled to apply the initial model to second local data of the second new source, and average the aggregated updates to the initial model and a second new update to the initial model based on the second new source applying the initial model to the second local data to obtain a second new aggregated updated model;
receive the second new update to the initial model from the second new source; and
distribute, to a third new source, either the initial model or the first aggregated updated model.

6. A computer-implemented method for federated learning, comprising:
aggregating, in a memory system, a first set of updates to an initial model in a federated learning process;
distributing, to sources of the first set of updates in a federation, a first aggregated updated model that aggregates updates to the initial model; and
distributing, to a first new source, either the initial model or the first aggregated updated model.

7. The computer-implemented method for federated learning of claim 6, further comprising:
initiating adding the first new source to the federation;
aggregating a second set of updates to the first aggregated updated model from the federation including the first new source;
distributing, to sources of the second set of updates in the federation, a second aggregated updated model that aggregates updates to the first aggregated updated model; and
distributing, to a second new source, the second aggregated updated model.

8. The computer-implemented method for federated learning of claim 7, further comprising:
initiating adding the second new source to the federation;
aggregating a third set of updates to the second aggregated updated model from the federation including the second new source;
distributing, to sources of the third set of updates in the federation, a third aggregated updated model that aggregates updates to the second aggregated updated model; and
distributing, to a third new source, the third aggregated updated model.

9. The computer-implemented method for federated learning of claim 6, further comprising:
initiating addition of the first new source to the federation, wherein the first new source is enabled to apply the initial model to first local data of the first new source, and average the aggregated updates to the initial model and a first new update to the initial model based on the first new source applying the initial model to the first local data to obtain a first new aggregated updated model;
receiving the first new update to the initial model from the first new source; and
distributing, to a second new source, either the initial model or the first aggregated updated model.

10. The computer-implemented method for federated learning of claim 9, further comprising: initiating addition of the second new source to the federation, wherein the second new source is enabled to apply the initial model to second local data of the second new source, and average the aggregated updates to the initial model and a second new update to the initial model based on the second new source applying the initial model to the second local data to obtain a second new aggregated updated model;
receiving the second new update to the initial model from the second new source; and
distributing, to a third new source, either the initial model or the first aggregated updated model.

11. A tangible non-transitory computer readable medium that stores a computer program, wherein the computer program, when executed by a processor, causes a computer apparatus to:
distribute, to sources of a first set of updates to an initial model in a federated learning process in a federation, a first aggregated updated model that aggregates the first set of updates to the initial model in the federated learning process; and
distribute, to a first new source, either the initial model or the first aggregated updated model.

12. The tangible non-transitory computer readable medium of claim 11, wherein the computer program, when executed by a processor, causes the computer apparatus further to:
initiate adding the first new source to the federation;
aggregate a second set of updates to the first aggregated updated model from the federation including the first new source;
distribute, to sources of the second set of updates in the federation, a second aggregated updated model that aggregates updates to the first aggregated updated model; and
distribute, to a second new source, the second aggregated updated model.

13. The tangible non-transitory computer readable medium of claim 12, wherein the computer program, when executed by a processor, causes the computer apparatus further to:
initiate adding the second new source to the federation;
aggregate a third set of updates to the second aggregated updated model from the federation including the second new source;
distribute, to sources of the third set of updates in the federation, a third aggregated updated model that aggregates updates to the second aggregated updated model; and
distribute, to a third new source, the third aggregated updated model.

14. The tangible non-transitory computer readable medium of claim 11, wherein the computer program, when executed by a processor, causes the computer apparatus further to:
initiate adding the first new source to the federation, wherein the first new source is enabled to apply the initial model to first local data of the first new source, and average the aggregated updates to the initial model and a first new update to the initial model based on the first new source applying the initial model to the first local data to obtain a first new aggregated updated model;
receive the first new update to the initial model from the first new source; and
distribute, to a second new source, either the initial model or the first aggregated updated model.

15. The tangible non-transitory computer readable medium of claim 14, wherein the computer program, when executed by a processor, causes the computer apparatus further to:
initiate adding the second new source to the federation, wherein the second new source is enabled to apply the initial model to second local data of the second new source, and average the aggregated updates to the initial model and a second new update to the initial model based on the second new source applying the initial model to the second local data to obtain a second new aggregated updated model;
receive the second new update to the initial model from the second new source; and
distribute, to a third new source, either the initial model or the first aggregated updated model.

16. An artificial intelligence aggregation system, comprising:
sources each comprising a computer with a memory that stores instructions and a processor that executes the instructions;
a computer with a memory that stores instructions, a processor that executes the instructions, and a memory system that aggregates a first set of updates to an initial model in a federated learning process, wherein the computer executes the instructions to:
distribute, to the sources of the first set of updates in a federation, a first aggregated updated model that aggregates updates to the initial model; and
distribute, to a first new source, either the initial model or the first aggregated updated model.
